(19) United States
(12) Patent Application Publication
(10) Pub. No.: US 2018/0194258 A1
(43) Pub. Date: Jul. 12, 2018

(54) BEVERAGE-PREPARATION APPARATUS FOR A VEHICLE AND METHOD FOR OPERATING THE SAME

(71) Applicant: AIR-ELTEC PATENT UG (HAFTUNGSBESCHRÄNKT), Herborn (DE)

(72) Inventor: ANDREAS STRAUSS, Hünenberg (CH)

(73) Assignee: GENESIS PATENT AG, Hünenberg (CH)

(21) Appl. No.: 15/558,487

(22) PCT Filed: Mar. 4, 2016
(86) PCT No.: PCT/EP2016/054673

§ 371 Date: Sep. 14, 2017

(30) Foreign Application Priority Data
Mar. 5, 2015 (DE) 10 2015 103 239.2

(51) Int. Cl. B60N 3/18; A47J 31/56

(52) U.S. Cl. CPC B60N 3/18; B67D 3/0077; B67D 2210/00089; A47J 31/56

(57) ABSTRACT

Mobile beverage-preparation apparatus for preparing beverages, in particular hot and/or cold ones, using at least one beverage extract (beverage preparation) and for dispensing the prepared beverage (beverage dispensing) in a vehicle. The beverage-preparation apparatus has a mobile housing, which is configured for accommodating at least one extract container in an interchangeable manner. The at least one extract container is configured for accommodating the beverage extract and has at least one container information item. The container information item is representative of an identifier of the extract container, of the volume of the extract container (container volume) or of the type of beverage extract. The extract container may have a number of these container information items at the same time. Furthermore, the beverage-preparation apparatus has a communications device, which is configured for communicating one or more of the container information items, in particular to a higher-level communications device in particular of the vehicle.

The present invention relates to a beverage-preparation apparatus for a vehicle and method for operating the same. Although the invention is described in the context of aircrafts, it can also be used advantageously in other vehicles.

It is known state of the art to provide vehicles with beverage-preparation apparatuses for preparing and dispensing different hot and/or cold beverages. There is often a need for special requirements for beverage-preparation apparatuses used in vehicles considering their reliability, since there is often no space available for a reserve beverage-preparation apparatus.

It is an object of the invention to provide a mobile beverage-preparation apparatus which can better meet the demands placed on it with regard to its reliability.

According to a first aspect of the invention, this object is achieved by a mobile beverage-preparation apparatus for preparing, in particular hot and/or cold, beverages with at least one beverage extract (beverage preparation) and for dispensing the prepared beverage (beverage dispensing) in a vehicle as described below. According to a second aspect of the invention, this object is achieved by a method for operating the beverage-preparation apparatus.

The beverage-preparation apparatus according to the first aspect comprises a mobile housing, which is configured for accommodating at least one extract container in an interchangeable manner. The beverage-preparation apparatus can accommodate several extract containers in an interchangeable manner at the same time, which then can be removed individually. The at least one extract container is configured for accommodating the beverage extract and provides at least one container information item. The container information item is representative of an identifier of the extract container, of the volume of the extract container (container volume) or of the type of beverage extract. The extract container can provide several container information items at the same time.

Further the beverage-preparation apparatus comprises a communication device, which is configured for transmitting one or several container information items, in particular to the higher-level communication device in particular of the vehicle.

In particular if at least one of the beverage extracts is running low, and/or if an undesirably low residual stock of one of the beverage extracts remains undetected and/or if an undesirably low residual content of the corresponding extract container remains undetected, the supply of the corresponding beverage during the vehicle operation can be affected. However, since the beverage-preparation apparatus according to the first aspect of the invention comprises a communication device, an undesirably low residual stock of at least one of the beverage extracts and/or an undesirably low residual content of the corresponding extract container can be transmitted to the higher-level communication device and an exchange of the corresponding extract container or its anew filling with beverage extract especially at the destination of the vehicle can be provided. Thereby the basic problem can be solved.

The method according to the second aspect of the invention serves for the operation of a beverage-preparation apparatus for preparing, in particular hot and/or cold, beverages with at least one beverage extract (beverage preparing) and dispensing the prepared beverages (beverage dispensing) in a vehicle. Preferably, the beverage-preparation apparatus accords to the first aspect of the invention.

The method comprises the step:
S0 Transmitting at least one container information item, wherein the container information item is representative of an identifier of the extract container for accommodating the beverage extract, of the volume of the extract container (container volume) or of the type of beverage extract, wherein the extract container is accommodated in an interchangeable manner in a mobile housing of a beverage-preparation apparatus, by a communication device of the beverage-preparation apparatus, in particular to a higher-level communication device.

In particular if at least one of the beverage extracts is running low, and/or if an undesirably low residual stock of one of the beverage extracts remains undetected and/or if an undesirably low residual content of the corresponding extract container remains undetected, the supply of the corresponding beverage during the vehicle operation can be affected. However, since the method according to the second aspect of the invention comprises step So, an undesirably low residual stock of at least one of the beverage extracts and/or an undesirably low residual content of the corresponding extract container can be transmitted to the higher-level communication device and an exchange of the corresponding extract container or its anew filling with beverage extract especially at the destination of the vehicle can be provided. Thereby the basic problem can be solved.

In the context of the invention an extract container is in particular an independent container, which can accommodate in particular liquid or powdery beverage extract and from which the beverage extract can be withdrawn to prepare the beverages.

In the context of the invention a container information item is an information assigned to an extract container, wherein the information is representative of an identifier of the extract container, of the volume of the extract container (container volume) or of the type of beverage extract accommodated by the extract container. Also considered as container information item in the context of the invention are:
an amount indication which refers to the amount M0 of beverage extract which was initially contained in the extract container, wherein it's technically possible that the initially contained amount M0 in the extract container can not be withdrawn completely
a residual content M determined by the control device of the beverage-preparation apparatus, which indicates the amount of beverage extract currently remaining in the extract container
a date which indicated the shelf life of the beverage extract
a date which indicates the point in time when the extract container is accommodated in the beverage-preparation apparatus.

In the context of the invention a communication device is a device, which can receive, request or read one or several container information items and which can transmit one or several container information items to a receiver, in particular to a higher-level communication device, in particular on demand by the higher-level communication device or in particular on demand by an electronic control device of the beverage-preparation apparatus. The communication device can be signal-connected with the control device of the beverage-preparation apparatus.

Preferred further developments are described below, which can advantageously be combined with one another without the opposite indication.

According to a further development the housing comprises at least a front housing element, wherein the front housing element can define an interior space of the housing opposite the surroundings.

According to a further development the communication device is configured to transmit on demand by the higher-level communication device at least one of the container information items. Preferably the communication device transmits exclusively on demand of the higher-level communication device. This higher-level communication device can be a vehicle-specific communication device. This development can provide the advantage that an error of the vehicle operation, in particular an error considering the vehicle electronics can be counteract by an activity of the communication device.

According to a further development the communication device is configured for radio communication. The frequency can be greater than 300 Mhz. This development can provide the advantage, that the transmission can be carried out by the communication device from any location inside or outside the vehicle.

According to a further development, the communication device comprises a GSM-circuit, which can be activated on demand by the higher-level communication device. This further development can provide the advantage that a radio-induced operational failure of the vehicle operation, in particular a radio-induced operational failure of the vehicle electronics, can be counteracted by an activity of the communication device.

According to a further development, one or more of the container information item are provided with a graphical code. The graphical code can be defined as a sequence of differently wide black and white stripes or as differently wide dashes or dots and intermediate gaps with the highest possible contrast (2D code) or as so-called QR code. The graphic code can be connected to a wall of the extract container and/or arranged on an outer surface of the extract container.

Alternatively or additionally, one or more of the container information items are provided with an RFID-chip. The RFID-chip can be connected to a wall of the extract container and/or can be arranged on a circumferential surface of the extract container.

According to a further development, the communication device comprises a sensor for RFID-chips and/or for graphical codes, or is signal-connected to such a sensor. In particular for a graphical code, the sensor is configured with a CCD element and can be arranged adjacent to one of the container accommodations explained below.

According to a further development, the beverage-preparation apparatus comprises an electronic control device, in particular which can determine a residual content of the extract container depending on the volume of the at least one extract container and depending on the amount of beverage extract withdrawn for the beverage preparation. The control device can be configured with a microprocessor or as a storage-programmable controller. The control device can determine the residual content M of the extract container by repeatedly subtracting the amount M1 required or to be withdrawn for the preparation of a beverage from the amount M0 initially contained in the extract container, wherein N is the number of beverages prepared with this beverage extract: M=M0−N*M1.

According to a further development, the control device is configured for requesting the communication device to transmit one of the container information items, in particular the type of beverage extract, when the residual content M of the corresponding extract container drops below a predetermined residual content Mg for the first time. In this case, the predetermined residual content Mg can be regarded as the minimum required stock of the beverage extract for a next operating interval of the vehicle.

According to a further development, the control device is configured to set an extract-bound Flag Fg when the residual content M of the corresponding extract container drops below the predetermined residual content Mg for the first time. The control device can store the extract-bound flag in a data storage unit of the beverage-preparation apparatus.

According to a further development, the control device is configured to request the communication device to transmit one of the container information items, in particular the type of beverage extract, depending on a date coded as container information item.

According to a further development, the communication device is configured to transmit the residual content M of at least one of the extract containers determined by the control device in combination with at least one of the container information items of the same extract container, in particular in combination with the type of beverage extract. This development can have the advantage that the corresponding beverage extract for filling the extract container or a new extract container with the same beverage extract can be provided for exchange at the destination of the vehicle.

According to a further development, the control device is configured:
for determination of the residual content M of one of the extract containers, in particular by means of: M=M0−N*M1,
for setting an extract-bounded flag Fg if the residual content of the extract container drops below the corresponding predetermined residual content Mg for the first time, and
for transmitting the extra-bounded flag Fg to the communication device, in particular in combination with the type of the beverage extract accommodated by the extract container.

The communication device of this further development is configured to transmit the extract-bound flag, in particular in combination with the type of the beverage extract withdrawn from the extract container, on demand by a higher-level communication device. This development can have the advantage that the corresponding beverage extract for filling the extract container or a new extract container with the same beverage extract can be provided for exchange at the destination of the vehicle.

According to a further development, the communication device is designed to transmit at least one of the container information items to a third communication device on demand by the higher-level communication device. This further development can offer the advantage that a radio-induced error of the vehicle operation, in particular a radio-induced error of the vehicle electronics, can be counteracted by an activity of the communication device. This further development can have the advantage that a person responsible for the beverage extracts who has access to the third communication device can be informed about an undesirably low residual content of one or more of the beverage extracts without a radio-induced error of the vehicle operation. This development can offer the advantage that a vehicle-specific communication device can demand the communication device of the beverage-preparation apparatus to transmit to a third communication device.

According to a further development, the control device is configured to detect an error or a state of the dispensing means or of the preparation means. The control device can generate a failure indicator or status indicator on the basis of the detected error or the detected state and store this failure indicator or status indicator in particular in combination with a value which indicates the date and/or the time of the error or the state in a data storage unit of the beverage-preparation apparatus or transmit it to the communication device. The failure indicator can indicate the type of error or its cause. This development can offer the advantage that operating data can be collected in the data storage unit for the beverage-preparation apparatus. This further development can have the advantage that an error can be transmitted to a higher-level communication device or to a third communication device.

According to a further development, the control device is configured to demand the dispensing means or preparation means to notifying a state or an error, in particular by means of a corresponding signal to the dispensing means or the preparation means. This development can have the advantage that operating data can be collected and/or that the control device can transmit the state or the error to the communication device.

According to a further development, the control device is configured to make available or transmit data from the data storage unit, in particular on demand by a higher-level control device, a higher-level communication device or a maintenance person. This further development can offer the advantage that the maintenance person can gain insights into the operation of the beverage preparation apparatus.

According to a further development, the beverage-preparation apparatus has preparation means for the preparation of a beverage (beverage preparation) with water and with at least one beverage extract, wherein the preparations are accommodated in the housing. The preparation means can have several different preparation elements in order to manage the preparation of beverages. The preparation means or their preparation elements are preferably used for:
the preparation of a particularly hot or cold beverage, using water and one of the beverage extracts,
the supply, preparation, transport of water,
the withdrawal of beverage extract from one of the extract containers for the preparation of a beverage,
for mixing water with a beverage extract,
to transport water and/or a prepared beverage towards the dispensing means.

The at least one extract container is, when accommodated in an interchangeable manner by the beverage-preparation apparatus or the housing, fluid-connectable to the preparation means. At the same time, several of the extract containers with different beverage extracts can be fluid-connectable to the preparation means, so that the beverage-preparation apparatus can prepare and dispense various beverages.

According to a further development, one or more of the preparation elements of the preparation means are included in the following group, which comprises: pump element for transporting water from a water tank and/or beverage extract towards a beverage container, an electronic control device, a carbonizer, a CO2 storage device, a coolable preparation element, a heating device, an arrangement for tempering, a mixing unit for mixing water and beverage extract, a water filter, a water tank, a container accommodation for accommodating one of the extract containers.

According to a further development, the preparation means comprise at least one container accommodation which is configured for accommodating at least one container with a beverage extract. At the same time, access to the at least one container accommodation for exchanging the at least one container and/or for cleaning according elements is made possible when the element carrier explained below is extended from the housing and/or the front housing element is in the open position. The at least one container accommodation desirably allows at least one container with a beverage extract to be attached to the element carrier.

According to a further development, one of the preparation elements is coolable for the preparation of beverages (coolable element), wherein the form of a heat absorbing element, flown though be a cooling means, is adapted to the form of the coolable element, wherein the heat absorbing element is mechanically connected to the housing, wherein preferably the coolable element is mechanically connected to the element carrier explained below. The heat absorbing element has a contact surface, which serves for the heat conducting contact with the coolable element. Preferably, the heat absorbing element is part of a cooling device which also has a cooling compressor for compressing the cooling means and a heat exchanger for emitting heat energy to the environment, which is preferably arranged outside the housing. Advantageously, with the coolable element being separable or removable from the heat absorbing element there is no need for flexible pipe lines or hoses within the cooling device and/or towards the coolable preparation element.

According to a further development, the beverage-preparation apparatus has a cooling device for cooling the preparation means or for cooling one of the preparation elements, wherein the cooling device is accommodated inside the housing and stationary relative thereto. The cooling device has a heat absorbing element flown through with a cooling means, and can have a cooling compressor and a heat exchanger, which can be connected to one another in a fluid-conducting manner.

According to a further development, the beverage-preparation apparatus for preparing a hot beverage has a preparation element which is configured as a heating device for heating water used for the beverage preparation. Preferably, the heating device operates substantially without pressure and can heat water to the ambient pressure-dependent boiling temperature. The preparation element or the heating device is particularly preferably configured as a pressure less or atmospheric flow heater. The heating device can partially enclose a water line of the beverage-preparation apparatus. In this development, the beverage extract is formed as a syrup. Particularly because of the use of syrup during the preparation of the hot beverage, the increase in the pressure of the water or to a water temperature greater than 80° C. can be dispensed. The advantage of a technically simpler construction and/or a further improved operational safety of the beverage-preparation apparatus can be associated with this. Preferably, the heating device is connected to the element carrier explained below. This has the advantage that heating of the water used can take place considering the prevailing pressure conditions.

According to a further development, the beverage-preparation apparatus has dispensing means for dispensing the prepared beverage (beverage dispensing), wherein at least one dispensing element of the dispensing means is fluid-connected to the preparation means (first dispensing element). The first dispensing element can be accessible through a recess of the front housing element. In particular, dispensing means can be used to dispense water and/or the prepared beverage to an independent beverage container. At least one of the dispensing elements is fluid-connected to the preparation means for leading water and/or for leading a prepared beverage.

According to a further development, one or more of the dispensing elements are included in the following group, which comprises: a receptacle accommodation for an independent beverage container, for example a drinking receptacle or a thermally insulated storage receptacle, and a tap unit. The receptacle accommodation can be arranged below the tap unit.

According to a further development, the preparation means can be connected with the preparation element configured as tap unit in order to deliver the prepared beverage by means of the tap unit to an independent beverage container.

According to a further development, at least one of the dispensing elements of the dispensing means is configured for dispensing a beverage and is accessible through a recess of the front housing element. Alternatively, at least one of the dispensing elements for dispensing a beverage is extended from the front housing element into the surroundings of the beverage-preparation apparatus.

According to a further development, the receptacle accommodation has a receptacle support which is relatively movable to the tap unit. The receptacle support can be configured in such a way that the independent drinking receptacle can be inserted into the same or can be configured in such a way that the drinking receptacle can be placed on the same. In the latter case, it is advantageous if the receptacle support has a recess into which the drinking receptacle can be placed.

According to a further development, the tap unit has a number of dispensing points which preferably corresponds to the number of beverages which can be prepared by mixing water and beverage extract. Each dispensing point can have a separate outlet on the tap unit, and each dispensing point can comprise a separate supply line for supplying the prepared beverage or can be connected to such a supply line.

According to a further development, one of the dispensing elements is configured as detection element for detecting at least one dimension of an independent beverage container inserted into the receptacle accommodation, wherein the amount of the beverage prepared by the preparation means is dependent on the detected dimension. For this purpose, the detection element can be signal-connected to the preparation means. A height measure of the beverage container, a diameter of the beverage container and an angle between a wall of the beverage container and a vertical are considered as dimensions of the beverage container. Preferably, the beverage-preparation apparatus has feedback means for returning the detected dimension of the inserted beverage container to the preparation means. Due to such measures, the number of preparation steps can be reduced by the operator. The further development can have the advantage that an overflow during the filling of the beverage container and/or an undesirably low filling can be avoided.

According to a further development, the communication device is configured to transmit a received failure indicator or status signal by the control device, in particular concerning the dispensing means or the preparation means. The communication device can transmit the failure indicator to a higher-level communication device or on demand by the higher-level communication device to a third communication device. The further development can offer the advantage that a spare part can be provided at the destination of the vehicle for exchanging the relevant dispensing element or preparation element.

According to a further development, the beverage-preparation apparatus can comprise a substantially box-shaped housing with at least one front housing element. Also, a housing element, on which an operating device of the beverage-preparation apparatus is arranged or through which a receptacle accommodation for an independent beverage container is accessible, is considered as a front housing element. In addition, the housing can have a rear housing element as well as in each case two upper, lower and lateral housing elements. The dimensions of the housing or of the housing elements are preferably standardized for use in different types of aircrafts, preferably according to an ARINC standard. In this case, the housing elements can be plate-like. Furthermore, these housing elements preferably consist of a light metal or a light metal alloy or an equivalent synthetic or a multicomponent material. The housing can have rollers for transport within the vehicle.

According to a further development, the housing is configured for accommodating or for use in a standard slot in a galley of an aircraft, a ship, a rail vehicle, an omnibus or a camping vehicle, preferably measured.

According to a further development, the beverage-preparation apparatus comprises an element carrier on or upon which one or more of the dispensing elements as well as one or more of the preparation elements are mounted. The element carrier can thereby be moved translationally substantially parallel to the upper, lower and lateral housing elements so that the element carrier can be extended out of the housing at least partially. The mounting of the dispensing means or preparation means can be prepared in a known manner. In particular, it is possible to configure the element carrier in frame construction and to adjust the respective dispensing means or preparation means to the appropriate support elements of the element carrier. The dispensing means and/or the preparation means can be mounted hanging or standing. In order to realize translational mobility of the element carrier, the element carrier can be guided with a suitable bearing in the housing. The bearing can in this case take place, in particular, via roller bearings on which the element carrier is movable mounted. The element carrier can be guided for its translation with one or two rails, which are preferably mechanically connected to one of the housing elements. The element carrier can have a locking recess into which a controllable locking element of the beverage-preparation apparatus can engage, in particular when the housing is closed or when the element carrier is completely accommodated by the housing. Preferably, the locking element is mounted in a housing-fixed manner.

According to a further development, beverage extracts can be used in particular extracts for the preparation of coffee or tea, or syrups in particular for hot beverages or other extracts for the preparation of cold beverages. The beverage extracts can be in liquid or dry form. In particular, a syrup can be used for the preparation of cold beverages, while a beverage extract in the form of granules or powders can be used for the preparation of hot beverages.

According to a further development, a recess can be configured in the front housing element, in which the dispensing means are provided and arranged for dispensing the prepared beverage. The dispensing means can be different in type and can, in particular, include a supply line which dispenses the beverage already prepared, or can have a plurality of supply lines which can lead different finished beverages separated from each other in the direction of the dispensing means, thereby an impairing of the taste of a finished beverage because of the previously dispensed beverage can be reduced. The recess in the front housing element can be configured that it is possible to pass a beverage container to be filled through the front housing element. Thereby it possible to bring the beverage container to be filled into the interior of the housing in a corresponding arrangement with the dispensing means. However, it is also possible for the front housing element to be configured in such a way that the recess is provided in the form of a deepening which defines a space which is separated from the interior of the housing and is accessible from a front side of the housing.

According to a development, at least one or more, preferably all, of the preparation means in the mounted state of the beverage-preparation apparatus can be accessible exclusively via the front housing element. For this purpose, the front housing element can be configured to be translational and/or rotatory movable. The front housing element can be detachable, slidable, or pivotably arranged with respect to the remaining housing members. Also, it is possible to arrange the front housing element in such a way to perform a combined movement. In this context, the front housing element can, in particular, be connected to other housing elements via a hinge and/or lever mechanism. This arrangement has the advantage that in the case of access to the preparation means exclusively through the front housing element, failures or accidents or injuries can be avoided because access is not provided by other means. Advantageously, preparation means or dispensing means of the beverage-preparation apparatus can be more easily accessible for maintenance, replacement and/or cleaning. As a result, a certain or required hygienic state of the beverage-preparation apparatus can be established more simply. Advantageously, maintenance or replacement of a preparation or dispensing means, which is necessary for the functionality of the beverage-preparation apparatus, can be possible with less effort.

According to a development, in the beverage-preparation apparatus, in the extended position of the element carrier, at least a part of the preparation means is made possible. In this context, the dispensing means and the preparation means can be arranged such that the dispensing means are accessible in a state in which the element carrier is in the retracted position and access to the preparation means is possible only when the element carrier is in the extended position. In this context, it is possible to allow access to at least a part of the preparation means from one side of the element carrier.

According to a development, the front housing element can be fastened to the element carrier and can be moved translationally together with the element carrier. Due to such an embodiment, it is not necessary to separate the front housing element from the housing in a separate step in order to allow the element carrier to be extended. Thus, a transfer of the element carrier from the retracted position to the extended position is facilitated because less work steps are required for this purpose.

According to a further development, the front housing element can also be mounted pivotably relative to the housing and can be moved between an open and closed position. In the closed position, the front housing element thereby prevents extension of the element carrier into the extended position and can therefore serve as a locking means of the element carrier in the retracted position. The front housing element is configured in such a way that the dispensing means can be reached in the closed position. If, in particular, the dispensing means are fixedly connected to the element carrier, the front housing element is desirably formed with a recess through which the dispensing means are accessible. However, it is also possible to attach the dispensing means or at least a part thereof to the front housing element. In this case, the dispensing means are also pivotally arranged relative to the housing and pivot together with the front housing element between an open and a closed position. In this context, the front housing element can be mounted on another housing element, in particular by means of a hinge mechanism.

According to a further development, the element carrier can be extended out of the housing after the front housing element is moved into the open position. In other words, the position of the front housing element restricts the mobility of the element carrier. The front housing element can thus serve as a barrier element with regard to the mobility of the element carrier in the housing.

According to a preferred development, the front housing element is pivotally mounted relative to the element carrier on the element carrier. As a result, the element carrier can be moved together with the front housing element and can be moved between an open and closed position. Due to the pivotable arrangement of the front housing element, access to the preparation means and/or dispensing means located in the front housing region is possible in the open position. At the same time, however, the element carrier can be extended together with the front housing element.

According to a further development, in the retracted state of the element carrier the at least one coolable element can be brought into thermal contact with a heat absorbing element of the cooling device, while in the extended state of the element carrier it is spaced apart from the heat absorbing element. The cooling device thus does not have to be mounted on the element carrier, but can remain stationary in the housing when the element carrier is brought into the extended position. As a result, the weight to be carried by the element carrier can be reduced. By arranging the heat absorbing element stationary in the housing, flexible lines to the heat receiving element can be dispensed. With the stationary arrangement of all parts of the cooling device, in particular of its heat absorbing element, cooling compressor and heat exchanger, in the housing, these parts can be connected to one another in a fluid-conducting manner with substantially bend-resistant pipe lines. As a result, the operating time of the cooling device can be extended. Advantageously, with the physical division into the coolable preparation element and the through-flowable heat absorbing element associated with the cooling device, hoses within the cooling device can be dispensed.

According to a further development, the coolable preparation element has a carbonizer which can supply CO2 to the water or to the prepared beverage. In particular, this carbonizer forms the coolable preparation element.

According to a further development, the heat absorbing element can be configured as a heat exchanger into which the carbonizer can be inserted in such a way that the heat exchanger can be connected to at least one section of the outer surface of the carbonizer in a heat-conducting manner, in particular form-closed or force-closed.

According to a further development, the beverage-preparation apparatus comprises the pump element, the control device with an operating device, the carbonizer with the CO2 storage unit, the cooling device for cooling the carbonizer and/or the water used, wherein the beverage-preparation apparatus is configured to dispense a cold beverage made out of water and of at least one beverages extract at the tap unit.

According to a further development, the heat absorbing element is configured with a deformable cushion, which can be acted on by a force component in the direction of the coolable preparation element. In particular when the element carrier is brought into its retracted state and the coolable preparation element is in heat-conducting contact with the heat absorbing element, the heat absorbing element is acted on, preferably spring-loaded, with a force component in the direction of the coolable preparation element for improved thermal contact.

According to a further development, when the coolable preparation element, configured in particular as a carbonizer, has a curved circumferential surface which faces the heat absorbing element, the contact surface is also formed with a curvature or the heat absorbing element is formed partially in the form of a shell. In particular, the radius of curvature of the contact surface substantially corresponds to the radius of the curved circumferential surface. If the coolable preparation element, which is configured in particular as a carbonizer, has a substantially flat circumferential surface which faces the heat absorbing element, the heat absorbing element also has a substantially planar contact surface.

According to a further development, an improved cooling performance is provided by a from the contact surface different circumferential surface of the heat absorbing element which is thermal insulated or by the heat absorbing element comprising an insulating layer facing away from the coolable preparation element.

According to a further development, one of the preparation means is configured as a group of mixing devices (mixing battery), which are each used for mixing one of the beverage extracts with water. Preferably, the mixing battery is connected by means of a plurality of pipe lines to different dispensing points of a dispensing means configured as a tap unit, whereby a taste impairment of a finished beverage by the previously dispensed beverage can be reduced or avoided. In order to utilize the gravity during the supply of one of the beverage extracts, the extract container can be arranged with respect to the gravity above the mixing battery. The mixing battery can be connected to different extract containers via separate supply lines, in particular to counteract the taste impairment of the finished beverages.

According to a further development, the beverage-preparation apparatus has a coolable preparation element, a cooling device and a preparation means configured as a heating device. Preferably, the coolable preparation element is configured as a carbonizer. Preferably, the coolable preparation element and/or the heating device are mechanically connected to one of the element carriers. Preferably, the water is passed through two different supply lines to the mixing battery, one of the supply lines carrying cooled water and the other of the pipes carrying the heated water. This refinement of the beverage-preparation apparatus can prepare both hot and cold beverages.

According to a further development, the beverage-preparation apparatus has a signaling element which can notify an opened opening of the housing or an actuation of the front housing element, in particular by means of an electronically processable signal. For this purpose, the signaling element can be fastened, adjacent to the front housing element, to one of the housing elements or to a wall of the housing. The signaling element can be configured as an electromechanical switch, in particular a microswitch, and/or can be electrically connected to an electronic control device of the beverage-preparation apparatus.

According to a further development which comprises the signaling element and an electronic control device, the beverage-preparation apparatus can be transferred, in particular, by a signal of the signaling element into a maintenance mode. In the maintenance mode, at least one of the preparation means is not energized or switched off. The maintenance mode can have one or more of the following characteristics, in particular triggered by the control device:
Disconnected pump unit, heating device and/or cooling device, and/or
A coolable preparation element, in particular configured with a carbonizer, is spaced apart from a housing-fixed heat absorbing element of a cooling device of the beverage-preparation apparatus, and/or
The housing is open, and/or
The element carrier is extended or can be extended, and/or
A water shut-off valve of the beverage-preparation apparatus is closed, and/or
The dispensing point is blocked, and/or
A looking element of the beverage-preparation apparatus which can counteract a displacement of the element carrier, particularly which can interfere with the element carrier, is loosened and/or
A preparation means can be cleaned or exchanged, and/or
A defective assembly of the beverage-preparation apparatus can be repaired or exchanged
An extract container can be changed.
This development can have the advantage that a danger to the surroundings by the preparation means, energy-assisted components and/or water-carrying components is reduced.

According to a further development, the beverage-preparation apparatus has a water container and an electrical energy store unit or a secondary battery. This development can offer the advantage that the beverage-preparation apparatus can be operated temporarily without supply lines.

Advantageously, an arrangement comprises a beverage-preparation apparatus according to the first aspect or according to one of the further developments and at least one of said extract container, wherein the extract container is accommodated by the beverage-preparation apparatus in an interchangeable manner. Preferably, a plurality of these extract containers are simultaneously accommodated by the beverage-preparation apparatus in an interchangeable manner.

Advantageously, a vehicle, in particular an aircraft, comprises one beverage-preparation apparatus according to the first aspect or according to one of the aforementioned further developments.

A further development of the method of the second aspect comprises the steps:
S1 Reading a container information item of at least one the extract containers (first extract container), in particular by the communication device or by a sensor which is signal-connected to the communication device, in particular reading the container volume of the first extract container or the amount M0 of the beverage extract initially contained in the extract container, in particular prior to step S3,
S2 Determining the residual content M of the first extract container, in particular by means of a control device of the beverage-preparation apparatus, in particular including setting an extract-bounded flag when the residual content M drops below a predetermined residual content Mg, S3 Receiving a demand o the higher-level communication device, in particular by the communication device, in particular including transmitting a demand to the control device
S4 Transmitting the residual content M of at least one of the extract containers in combination with at least one of the container information items of the extract container, or transmitting the extract-bound flag, in particular by the communication device, in particular after step S2, in particular after step S3.

During step S2, the determination of the residual content M is carried out with repeatedly subtracting of the amount M1 required or to be withdrawn for the preparation of a beverage from the amount M0 initially contained in the extract container, where N is the number of beverages prepared with this beverage extract: M=M0−N*M1.

Step S4 represents a concretion of the step S0, wherein the residual content M forms one of the transmitted container information items. Preferably, step S4 is realized instead of step S0.

According to a further development step S3 includes: checking at least one residual content M (step S3a) and/or setting the extract-bounded flag when the residual content M is below the predetermined residual content Mg (step S3b). The testing is carried out by comparing the residual content M with the predetermined residual content Mg. When the residual content M is below the predetermined residual content Mg, the control device sets the extract-bound flag.

According to a further embodiment, step S4 includes: transmitting the type of beverage extract of the extract container whose residual content M drops below the predetermined residual content Mg.

According to a further development, the steps are carried out in the sequence S3, S1, S2, S4.

A further development of the method of the second aspect comprises one or more of the following steps:
S5 Transmitting a failure indicator, in particular after step 3, in particular by the communication device, and/or
S6 Exchanging at least one of the extract containers in correlation with step S4, and/or
S7 Exchanging or maintaining one of the dispensing elements or one of the preparation elements in correlation with step S5.

A second method for operating a beverage-preparation apparatus for preparing and dispensing hot and/or cold beverages, in particular according to the first aspect or according to one of the aforementioned further developments, comprising the following steps:
S11 Opening a front housing element of a substantially box-shaped housing of the beverage-preparation apparatus, with translational and/or rotational movement of the front housing element,
S12 Cleaning or changing at least one preparation element of a plurality of the preparation elements of the beverage-preparation apparatus, wherein the preparation means are configured for preparing beverages with water and with at least one beverage extract, wherein the preparation means are accessible in the mounted state exclusively through the front housing element.
S13 Cleaning or changing at least one of a plurality of dispensing elements of the dispensing means of the beverage-preparation apparatus, in particular wherein the dispensing means for dispensing the prepared beverage are configured and arranged in a recess in the front housing element.
Steps S12 and S13 can be performed simultaneously or sequentially.

The second method can provide the advantage that preparation means or dispensing means of the beverage-preparation apparatus are more easily accessible for maintenance, replacement and/or cleaning. As a result, a certain or required hygienic state of the beverage-preparation apparatus can be established more easily. The second method can provide the advantage that maintenance or replacement of a preparation means or dispensing means, which is necessary for the functionality of the beverage-preparation apparatus, is possible with less effort.

A further development of the method of the second aspect comprises one or more of the following steps:
S14 extending the element carrier of the beverage-preparation apparatus, on which at least one of the dispensing elements and/or at least one of the preparation elements is mounted, from the housing, wherein the element carrier is movable guided substantially parallel to upper, lower and lateral housing elements of the housing, preferably before step S12, preferably in which an access to at least one or more of the preparation elements and/or at least one or more of the dispensing elements is possible in the extended position of the element carrier, and/or
S15 Transferring the beverage-preparation apparatus into a maintenance mode, in particular by an electronic control device of the beverage-preparation apparatus, in particular after a signal of a signaling element of the beverage-preparation apparatus, whereupon at least one of the preparation means is not energized, in particular on demand by the electronic control device, in particular before step 12, in particular before step 14.

Preferably, in particular on demand by the electronic control device, takes place during step S15:
Switching off a pump unit, heating device and/or cooling device of the beverage-preparation apparatus, and/or
Closing a water shut-off valve of the beverage-preparation apparatus, and/or
Blocking the dispensing point, and/or
Releasing a locking element of the beverage-preparation apparatus, which before the release counteracts a displacement of the element carrier, in particular interferes with the element carrier.

Following the step S15, can
the element carrier of the beverage-preparation apparatus be extended, and/or
the carrier-mounted coolable preparation element be spaced apart from the housing-fixed heat absorbing element, and/or one of the preparation elements, one of the dispensing elements, the cooling device, the heating device and/or another assembly of the beverage-preparation apparatus be cleaned, repaired and/or replaced.

This development can offer the advantage that a danger to the surroundings or a maintenance person by a preparation means, a dispensing means, an energized component and/or a water-carrying component of the beverage-preparation apparatus is reduced.

A third method for operating the beverage-preparation apparatus comprises the steps: S20 Detecting a state of the preparation means (state detection) by the control device, wherein the preparation means are configured to notify a failure state (error), in particular on demand by the communication device, in particular after step S3,
S21 Generating a failure indicator, in particular indicating the type of the error or its cause if an error of the preparation means is detected by the state detection, in particular by the control device,
S3 Receiving a demand from a higher-level communication device by the communication device,
S5 Transmitting the failure indicator by the communication device, in particular to the higher-level communication device or to a third communication device, in particular located at the destination location or at a spare part storage, in particular after steps S3 and S21.

Thereupon, a spare part or material for repairing the preparation element comprising the error can be held ready at the destination of the vehicle. This further development can offer the advantage that the time required for maintenance or repair of the beverage-preparation apparatus can be reduced.

### EXECUTION EXAMPLE

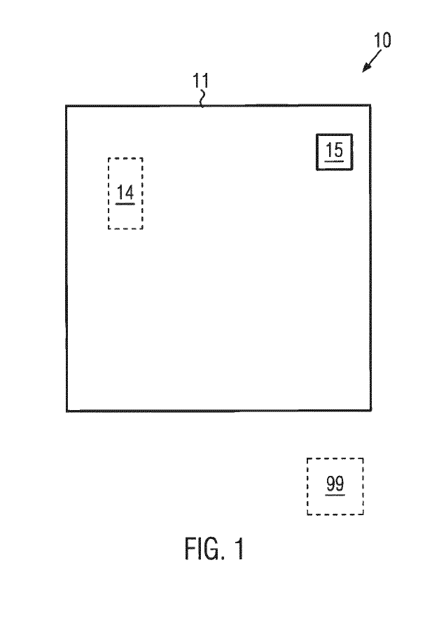

FIG. 1 shows schematically a first exemplary embodiment of the beverage-preparation apparatus,

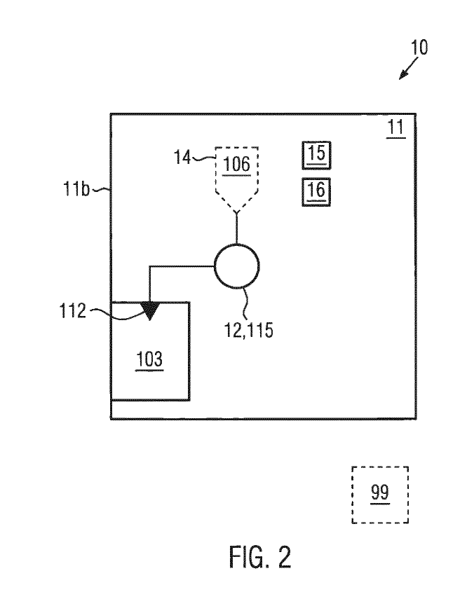

FIG. 2 schematically shows a second exemplary embodiment of the beverage-preparation apparatus,

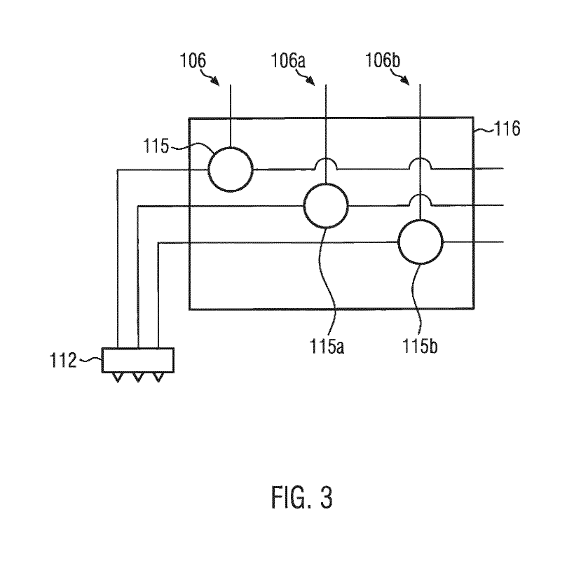

FIG. 3 schematically shows a detail of a further development of the beverage-preparation apparatus with mixing battery,

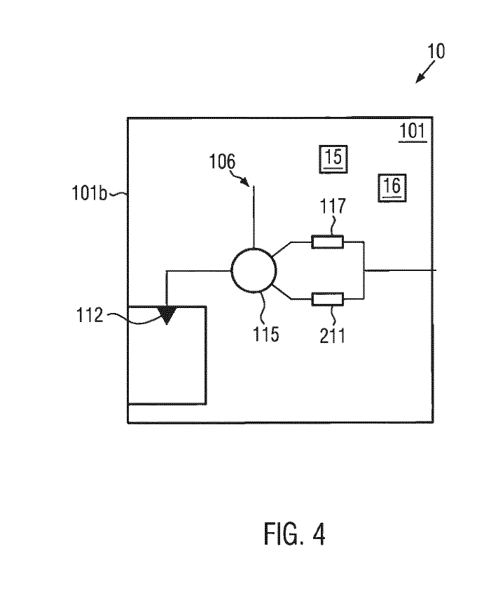

FIG. 4 shows schematically an embodiment of the beverage-preparation apparatus, which can prepare both cold and hot beverages,

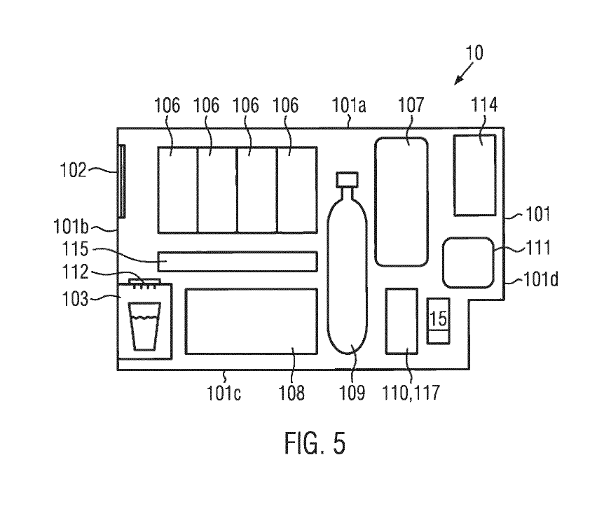

FIG. 5 shows schematically an embodiment of the beverage-preparation apparatus for cold beverages,

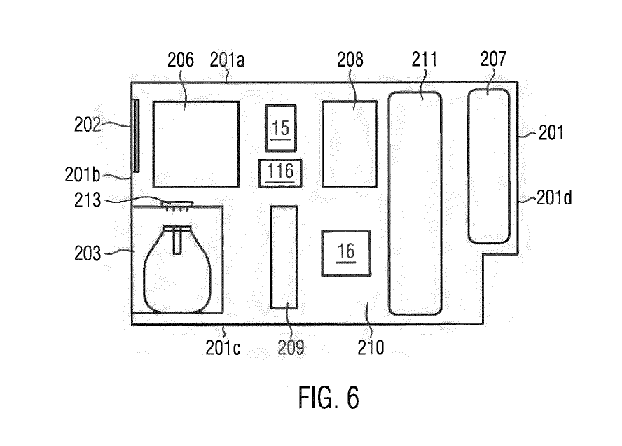

FIG. 6 shows schematically an exemplary embodiment of the beverage-preparation apparatus for hot beverages,

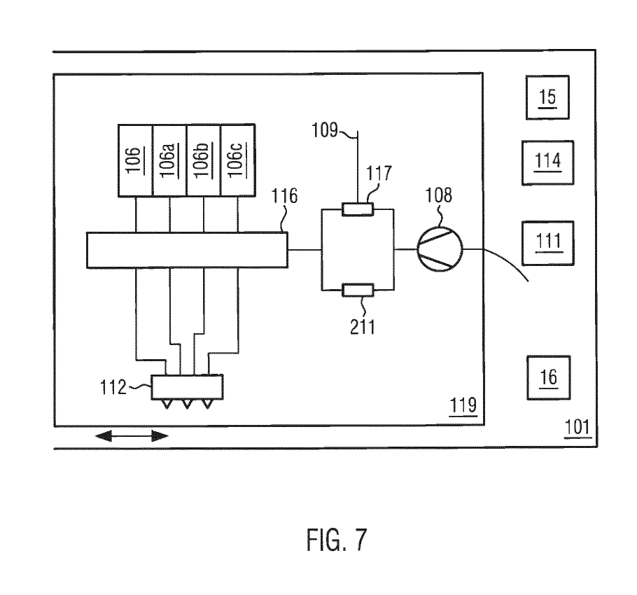

FIG. 7 schematically shows an embodiment of the beverage-preparation apparatus with an element carrier which can prepare both cold and hot beverages,

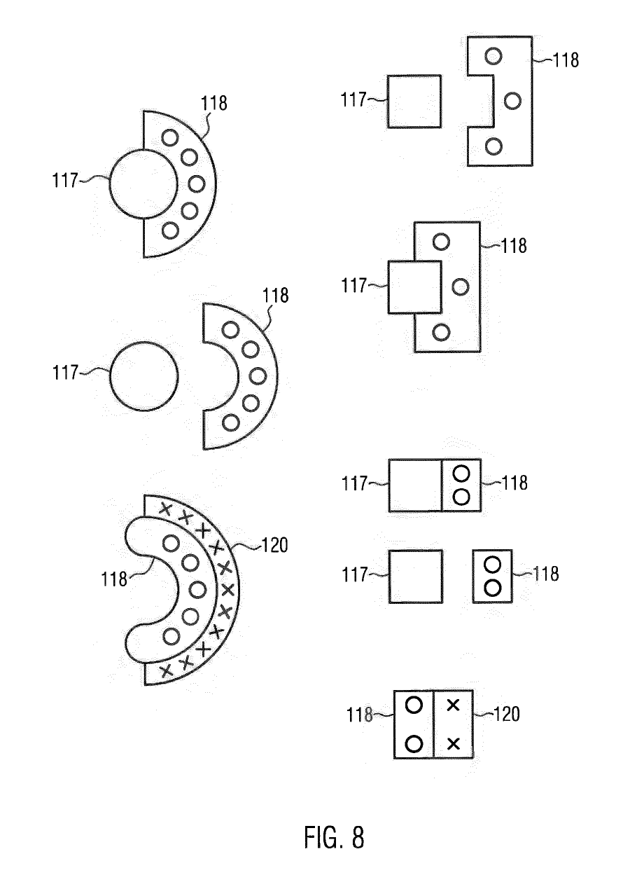

FIG. 8 shows schematically details of an exemplary embodiment of the beverage-preparation apparatus with a coolable preparation element and a through-flowable heat absorbing element

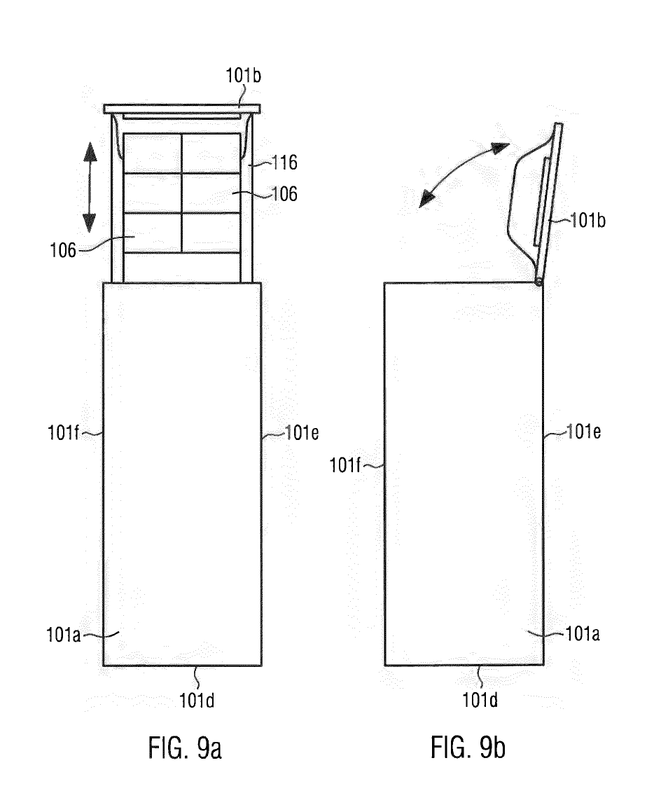

FIG. 9 shows schematically alternative exemplary embodiments of the beverage-preparation apparatus with element carrier,

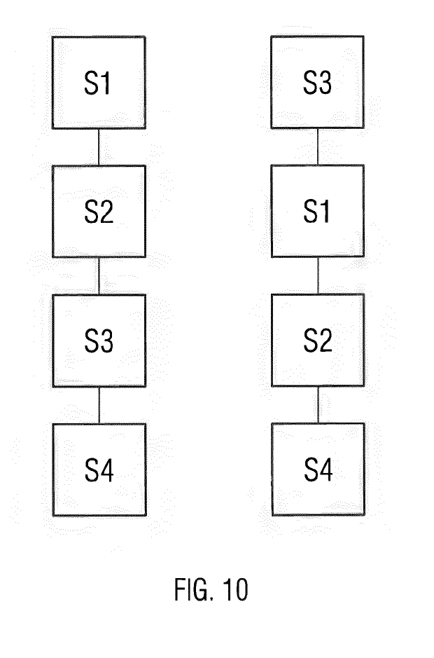

FIG. 10 shows a flowchart of the method according to the second aspect,

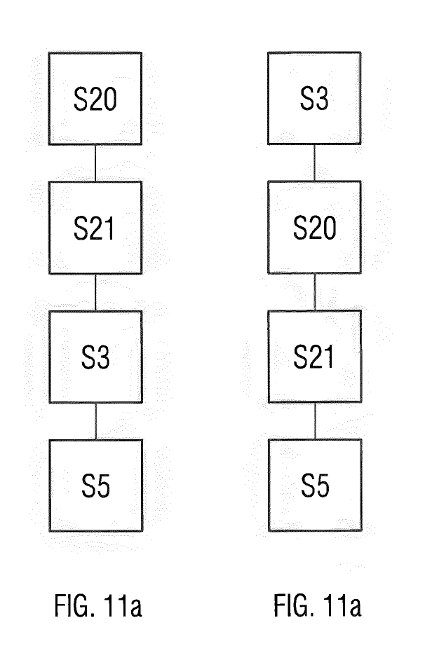

FIG. 11 shows a flowchart of a further development of the method of FIG. 10,

FIG. 12 shows a flowchart of a third method for operating one of the beverage-preparation apparatus.

FIG. 1 schematically shows a first exemplary embodiment of the beverage-preparation apparatus. The beverage-preparation apparatus 10 comprises the mobile housing 11 as well as the communication device 15. The independent extract container 14 which can be accommodated by the housing and the higher-level communication device 99 which is not associated with the beverage-preparation apparatus are shown by dashed lines. Preferably, the beverage-preparation apparatus comprises a secondary battery for supplying power to the electrical preparation means and a water container.

FIG. 2 shows schematically a second exemplary embodiment of the beverage-preparation apparatus. Differing the beverage-preparation apparatus of FIG. 1, the beverage-preparation apparatus additionally comprises preparation means 12, which comprise a mixing device 115, a receptacle accommodation 103 as well as a tap unit 112. The tap unit is arranged within the receptacle accommodation and is fluid-connected via a beverage supply line with the preparation means 12. A water supply line leads to the mixing device. The mixing device is fluid-connected to the independent extract container 14, wherein the extract container shown in dashed lines contains a beverage extract 106. Preferably, the beverage-preparation apparatus has a secondary battery for supplying power to the electrical preparation means and a water container.

FIG. 3 shows schematically a detail of a further development of the beverage-preparation apparatus with a mixing battery 116. The mixing battery comprises a plurality of mixing devices 115, 115a, 115b, which are respectively fluid-connected to the tap unit 112 via separate beverage supply lines, to each of which a beverage extract 106, 106a, 106b can be supplied and to which in each case a water supply line leads. The tap unit has a separate dispensing point for each beverage supply line. In this embodiment, a taste impairment of a prepared beverage has been counteracted.

FIG. 4 schematically shows an embodiment of the beverage-preparation apparatus configured for preparing and dispensing hot and cold beverages in a vehicle. Differing from the beverage-preparation apparatus from FIG. 2, the beverage-preparation apparatus is additionally configured with a coolable preparation element 117 and with a heating device 211. In particular, the coolable preparation element 117 is configured as a carbonizer. The heating device 211 and the coolable preparation element 117 are arranged in different branches or at various water supply lines upstream of the mixing device 115. Preferably, the beverage-preparation apparatus has a secondary battery for supplying power to the electrical preparation means and a water container.

FIG. 5 shows schematically an embodiment of the beverage-preparation apparatus for cold beverages. The beverage-preparation apparatus is configured with a substantially box-shaped housing 101; with preparation means for the preparation of beverages with water and at least one beverage extract 106; with dispensing means for dispensing the prepared beverage in a recess in the front housing element 101b; wherein the preparation means are accessible in the mounted state of the beverage-preparation apparatus exclusively via the front housing element 101b. For this purpose, the front housing element is configured to be translationally and/or rotatable movable.

The front housing member 101b comprises a recess formed as a deepening. The beverage-preparation apparatus comprises a plurality of container accommodations for containers with beverage extract 106 arranged side by side, a water filter 107, a pump element 108, a CO2 storage unit 109, a carbonizer 110, a cooling compressor 111, a mixing device 115, a receptacle accommodation 103 and a tap unit 112. Advantageously, the cooling compressor 111 and the heat exchanger 114 are mounted in a housing-fixed manner. Preferably, the cooling device of the beverage-preparation apparatus comprises a heat absorbing element, which is configured for heat-conducting contact with the carbonizer 110 and is mounted in a housing-fixed manner.

Pipes lines for leading the water, the beverage extract or the prepared beverage are not shown. The control device 16 is not shown. Advantageously, the water supplied via the water connection 104 passes through the water filter 107, the pump element 108, the carbonizer 110 and is mixed in the mixing device 115 with at least one of the beverage extracts 106. The prepared beverage is dispensed via the tap unit 112 into a beverage container located in the receptacle accommodation 103. Preferably, the various beverages are lead through separate pipe lines to different dispensing points of the tap unit 112, whereby a taste impairment of a prepared beverage by a previously dispensed beverage can be counteracted.

Preferably, the beverage-preparation apparatus comprises a secondary battery for supplying power to the electrical preparation means and a water container. Preferably, the beverage-preparation apparatus comprises detection means for at least one dimension of the beverage container, wherein the detected dimension is considered for the amount of the to be supplied water. At least one of the dispensing elements and/or at least one of the preparation elements can be maintained, cleaned or exchanged more easily after opening the front housing element.

Preferably, the water filter 107, the pump element 108, the CO2 storage unit 109, the carbonizer 110, the tap unit 112, the mixing device 115, are mounted on an element carrier of the beverage-preparation apparatus, wherein the element carrier is able to be displaced at least partially from the housing into the surroundings. Preferably, the beverage-preparation apparatus comprises one of the signaling elements and can be transferred into the maintenance mode. The housing preferably comprises rollers for transporting the beverage-preparation apparatus in the vehicle.

FIG. 6 shows schematically a further exemplary embodiment of the beverage-preparation apparatus configured for preparing and dispensing hot beverages. The beverage-preparation apparatus is configured with a substantially box-shaped housing 201 with at least one front housing element 201b; with preparation means for the preparation of beverages with water and at least one beverage extract 206; with dispensing means for dispensing the prepared beverage in a recess in the front housing element 201b; wherein the preparation means are accessible in the mounted state of the beverage-preparation apparatus exclusively via the front housing element 201b. For this purpose, the front housing element is configured to be translationally and/or rotatable movable.

The front housing member 201b comprises a recess which is configured as a deepening. The beverage-preparation apparatus has one or more container accommodations for containers with beverage extract 206, a water filter 207, a pump element 208, a control device 209, a water heating device 211, a receptacle accommodation 203 and a tap unit 213. Pipe lines for leading the water, the beverage extract or the prepared beverage are not shown.

Advantageously, the water supplied via the water connection 204 passes through the water filter 207, the pump element 208, the water heating device 211, and is mixed with at least one of the beverage extracts 206. The prepared beverage is dispensed via the tap unit 213 into a beverage container located in the receptacle accommodation 203. Preferably, different beverages are lead through separate pipe lines to different dispensing points of the tap unit 212.

Preferably, the beverage-preparation apparatus comprises a secondary battery for supplying power to the electrical preparation means and a water container. Preferably, one of the dispensing elements is configured as a detecting element for at least one dimension of the beverage container, whereby the detected dimension is considered for the dimensioning of the to be supplied water.

At least one of the dispensing elements and/or at least one of the preparation elements can be maintained, cleaned or exchanged more easily after opening the front housing element. Preferably, the beverage-preparation apparatus has one of the signaling elements and can be transferred into the maintenance mode. The housing preferably comprises rollers for transporting the beverage-preparation apparatus in the vehicle.

FIG. 7 shows schematically an exemplary embodiment of the beverage-preparation apparatus with an element carrier 119, which can prepare cold and hot beverages. The mixer battery 116, the tap unit 112, the heating device 211, the coolable preparation element 117, the CO2 storage unit 109, the pump element 108, as well as a plurality of container accommodations for extract containers with beverage extract 106, 106a, 106b, 106c are mechanically connected to the element carrier 119. Preferably, the coolable preparation element 117 is configured as a carbonizer. A heat exchanger 114, a cooling compressor 111, the communication element 15 are housing-fixed.

Although the heat absorbing element through which a cooling means can flow through is not shown, it is mechanically connected to the housing 101. In the illustrated position of the element carrier 119, which is retracted relative to the housing, the heat absorbing element is heat-conductible connected to the coolable preparation element 117. Preferably, in the retracted position of the element carrier, the heat absorbing element is acted upon by a force in the direction of the coolable preparation element 117. Preferably, the heat absorbing element is configured with a deformable cushion for improved thermal contact with the coolable preparation member 117. In a position, which is extended relative to the housing but not shown, of the element carrier 119, the heat absorbing element is spaced apart from the coolable preparation element 117. Advantageously, parts of the cooling device, including the heat exchanger 114, the cooling compressor 111 and the heat absorbing element (not shown), can be connected to one another with substantially bending-resistant pipe lines, thus improving the mechanical stability of the cooling arrangement. Advantageously, with the physical division into a coolable preparation element 117 and a through-flowable heat absorbing element flexible pipelines or hoses within the cooling device can be dispensed.

Preferably, the beverage-preparation apparatus comprises one of the signaling elements and can be transferred into the maintenance mode. The housing preferably comprises rollers for transporting the beverage-preparation apparatus in the vehicle. Preferably, the beverage-preparation apparatus has a secondary battery for supplying power to the electrical preparation means and a water container.

FIG. 8 shows schematically a detail of a further exemplary embodiment, with a coolable preparation means 117 and a heat absorbing element 118 through which a cooling means can flow. In particular, the coolable preparation element 117 is configured as a carbonizer. A circumferential surface of the second preparation means 118, which faces away from the coolable preparation element 117, can have an insulating layer 120 for improved cooling performance, which are shown in FIG. 8 below. On the left in FIG. 8, a coolable preparation element 117 with a substantially cylindrical cross section and a correspondingly adapted heat absorbing element 118 are shown. On the right in FIG. 11, a coolable preparation element 117 with a substantially prismatic cross section and a correspondingly adapted heat absorbing element 118 are shown.

FIG. 9a shows schematically a beverage-preparation apparatus in which at least one of the dispensing elements and at least one of the preparation elements are mounted on an element carrier 119 of the beverage preparation device. The element carrier 119 supports several adjacently arranged container accommodations for independent extract containers. The element carrier 119 can be displace partially outside the housing by means of translation, whereby dispensing means and preparation means are accessible for cleaning, maintenance or exchange. The front housing element 101b is mechanically connected to the element carrier 119. The element carrier 119 is preferably guided by means of at least one rail which is mechanically connected to one of the housing elements.

FIG. 9b shows another development in which the front housing element 101b is hingedly connected to a lateral housing element 101e. After pivoting the housing member 101b, whereupon an opening to the interior of the housing becomes free, dispensing means and preparation means are accessible for cleaning, maintenance or replacement through the opening. Preferably, at least one of the dispensing elements and at least one of the preparation elements are mounted on an element carrier 119 of the beverage-preparation apparatus. The element carrier 119 is preferably guided by means of at least one rail, which is mechanically connected to one of the housing elements 101e, 101f

FIG. 10 shows a flowchart of the method according to the second aspect, comprising the step S0: Transmitting at least one container information item, wherein the container information item is representative of on identifier of an extract container for accommodating the beverage extract, the volume of the extract container (container volume) or the type of beverage extract, wherein the extract container is accommodated in an interchangeable manner by a mobile housing of the beverage-preparation apparatus, by means of a communication device of the beverage-preparation apparatus, in particular to a higher-level communication device,

FIG. 11 shows flow diagrams of further developments of the method of FIG. 10. This further development of the method, which is particularly suitable for the beverage-preparation apparatus of the FIGS. 1, 2, 4, 5, 6, 7 and 9, comprises the steps:
S1 Reading one of the container information items of at least one of the extract containers (first extract container), in particular by the communication device or by a sensor signal-connected to the communication device, in particular reading the container volume of the first extract container,
S2 Determining the residual content M of the first extract container, in particular by means of a control device of the beverage-preparation apparatus, in particular including setting an extract-bounded flag when the residual content M drops below a predetermined residual content Mg,
S3 Receiving a demand from a higher-level communication device, in particular by the communication device, in particular including transmitting the demand to the control device,
S4 Transmitting the residual content M of at least one of the extract containers in combination with at least one of the container information item of the extract container, or transmitting the extract-bound flag, in particular by the communication device.

During step S2, the determination of the residual content M is carried out with repeatedly subtracting the amount M1 required or to be withdrawn for the preparation of a beverage from the amount M0 initially contained in the extract container, where N is the number of beverages prepared with this beverage extract: M=M0−N*M1. Step S4 is a concretion of the step S0 and is to be carried out in particular instead of step S0.

According to the flow chart shown to the left in FIG. 11 the steps are preferably executed in the sequence S1, S2, S3, S4. Alternatively, the steps are performed in the sequence S3, S1, S2, S4 according to the flow diagram shown on the right in FIG. 11.

FIG. 12 shows flow charts of a third method for operating a beverage-preparation apparatus comprising the steps:
S20 Detecting a state of the preparation means (state detection) by the control device, wherein the preparation means are configured to notify a failure state (error), in particular on demand by the communication device, in particular after step S3,
S21 Generating a failure indicator, in particular which indicates the type of the error or its cause, if an error of the preparation means is detected by the state detection, in particular by the control device,
S3 Receiving a demand from a higher-level communication device by the communication device,
S5 Transmitting the failure indicator by the communication device, in particular to the higher-level communication device or to a third communication device, in particular located at the destination location or at a spare part storage, in particular after steps S3 and S21.

Thereupon, a spare part or material for repairing the preparation element comprising the error can be held ready at the destination of the vehicle. This further development can offer the advantage that the time required for maintenance or repair of the beverage-preparation apparatus can be reduced.

According to FIG. 12a, the steps are preferably executed in the order S20, S21, S3, S5. Alternatively, the steps according to FIG. 12b are performed in the sequence S3, S20, S21, S5.

### REFERENCE MARK

11 housing
12 preparation means
13 dispensing means
14 extract container
15 communication device
16 control device
99 higher-level communication device
101 housing
101b front housing element
102 operating device
103 receptacle accommodation
104 water connection
105 electrical connection
106 beverage extract
107 water filter
108 pump element
109 CO2 storage unit
110 carbonizer
111 cooling compressor
112 tap unit
114 heat exchanger
115 mixing device
116 group of mixing devices, mixing battery
117 coolable preparation element
118 through-flowable heat absorbing element
119 element carrier
120 insulating layer
201 housing
201b front housing element
202 operating device
203 receptacle accommodation
204 water connection
205 electrical connection
206 beverage extract
207 water filter
208 pump element
209 control device
210 power supply unit
211 water heating device
213 tap unit
215 mixing device

1. A beverage-preparation apparatus for preparing and dispensing beverages in a vehicle using at least one beverage extract, comprising
a mobile housing configured and arranged for accommodating at least one extract container in an interchangeable manner, wherein the extract container is configured and arranged for accommodating the at least one beverage extract, and comprises at least one container information item, wherein the container information item is representative of at least one of an identifier of the at least one extract container, the volume of the extract container and the type of the at least one beverage extract; and
a first communication device configured and arranged for transmission of at least one of the container information items to a second communication device.

2. The beverage-preparation apparatus according to claim 1, wherein the first communication device is configured and arranged for transmitting, on demand by the second communication device of the vehicle, at least one of the container information items.

3. The beverage-preparation apparatus according to claim 1, wherein the first communication device is configured and arranged for radio communication.

4. The beverage-preparation apparatus according to claim 1, wherein the first communication device comprises a GSM-circuit, wherein the GSM-circuit is configured and arranged to be activated on demand by the second communication device.

5. The beverage-preparation apparatus according to claim 1, wherein the at least one container information item is provided with a RFID-chip or a graphical code.

6. The beverage-preparation apparatus according to claim 1, further comprising an electronic control device, and configured and arranged to determine the residual content M of the at least one extract container depending on its container volume and depending on the amount of beverage extract withdrawn from the extract container for preparing beverages.

7. The beverage-preparation apparatus according to claim 6, wherein the first communication device is configured and arranged to transmit the residual content M, determined by the control device, in combination with at least one of the container information items of the same extract container.

8. The beverage-preparation apparatus according to claim 1, further comprising preparation means configured and arranged for preparing beverages with water and with at least one of the beverage extracts, wherein the preparation means are accommodated in the housing, and wherein the at least one of the extract containers accommodated in the beverage-preparation apparatus is fluid-connectable to the preparation means.

9. The beverage-preparation apparatus according to claim 8, wherein at least one preparation elements of the preparation means is included in a group comprising a pump element, a carbonizer, a CO2 storage unit, an arrangement for tempering, a mixer unit, a water filter, a water tank, a container accommodation.

10. The beverage-preparation apparatus according to claim 8, wherein one of the preparation elements is configured as being coolable for preparing beverages using coolable preparation element, wherein the form of a heat absorbing element of the beverage-preparation apparatus, flown through by a cooling means, is adapted to the form of the coolable preparation element, and wherein the heat absorbing element is mechanically coupled to the housing.

11. The beverage-preparation apparatus according to claim 8, wherein one of the preparation elements is configured as a heating device configured and arranged for preparing hot beverages, wherein the heating device is configured and arranged to heat water to the ambient pressure-dependent boiling temperature, and wherein the beverage extract is in form of a syrup.

12. The beverage-preparation apparatus according to claim 8, further comprising dispensing means configured and arranged for beverage dispensing, wherein at least one dispensing element of the dispensing means is fluid-connectable to the preparation means.

13. The beverage-preparation apparatus according to claim 12, wherein at least one of the dispensing elements is included in a group comprising a receptacle accommodation for an independent beverage container and a tap unit.

14. The beverage-preparation apparatus according to claim 13, wherein one of the dispensing elements is configured as a detection element configured and arranged to detect at least one dimension of an independent beverage container inserted into the receptacle accommodation, wherein the amount of the beverage prepared by the preparation means is dependent on the at least one dimension detected by the detection element.

15. The beverage-preparation apparatus according to claim 6, wherein the first communication device is configured to transmit a failure indicator, received by the electronic control device, wherein the failure indicator concerns or is associated with the dispensing means or the preparation means.

16. The beverage-preparation apparatus according to claim 8, wherein at least one of the dispensing elements and/or at least one of the preparation elements is mechanically coupled with an element carrier, wherein the element carrier is translationally displaceable and at least partially displaceable in the surroundings of the housing, and configured and arranged for the exchange of one of the dispensing elements, one of the preparation elements or one of the extract containers, and wherein the coolable preparation element is mechanically coupled with the element carrier.

17. The beverage-preparation apparatus according to claim 1 and configured as an arrangement with at least one extract container, which is accommodated by the mobile housing in an interchangeable manner.

18. A vehicle with a beverage-preparation apparatus according to claim 1, wherein the vehicle is an aircraft, a watercraft, a rail vehicle, or a road vehicle.

19. A method for operating a beverage-preparation apparatus for preparing and dispensing beverages using at least one beverage extract in a vehicle using the apparatus of claim 1, comprising step:
S0 transmitting at least one container information item, wherein the container information item is representative of an identifier of the extract container for accommodating the beverage extract, of the volume of the extract container or of the type of beverage extract, wherein the extract container is accommodated in an interchangeable manner in a mobile housing of a beverage-preparation apparatus, by a first communication device of the beverage-preparation apparatus and to a second communication device.

20. The method according to claim 19 comprising the steps:
S1 Reading a container information item of at least one of the extract containers including reading the container volume and the amount of the beverage extract M0 initially contained in the extract container,
S2 Determining a residual content M of the at least one extract container using a control device,
S3 Receiving a demand, sent by the second communication device, by the first communication device,
S4 Transmitting the residual content M in combination with at least one of the container information items of the same container by the first communication device.

21. The method according to claim 20, wherein step S3 includes:
Comparing the residual content M with the predetermined residual content M by the control device and/or Setting an extract-bound flag, related to the extract, by the control device if the residual content M drops below the predetermined residual content M,

22. The method according to claim 19, and further comprising at least one of the steps:
S5 Transmitting a failure indicator by the first communication device, in particular after step S3, and/or
S6 Exchanging of at least one of the extract containers in correlation with step S4, and/or
S7 Exchanging or maintaining one of the dispensing elements or one of the preparation elements in correlation with step S5.

23. The method according to claim 19, and further comprising the steps:
S20 Detecting a state of the preparation means by the control device, wherein the preparation means are configured to notify a failure state (error) on demand by the first communication device after step S3,
S21 Generating a failure indicator if the state detection detects an error in the preparation means by the control device,
Receiving a demand, transmitted by the second communication device, by the first communication device
S5 Transmitting the failure indicator by the first communication device particular after the steps S3 and S21.
